(19) United States
(12) Patent Application Publication
(10) Pub. No.: US 2004/0096699 A1
(43) Pub. Date: May 20, 2004

(54) Current-responsive resistive component

(76) Inventors: Kathrin Doerr, Dresden (DE); Theresia Walter, Dresden (DE); Karl-Hartmut Mueller, Dresden (DE); Konstantin Nenkov, Dresden (DE); Ludwig Schultz, Dresden (DE)

Correspondence Address: JORDAN AND HAMBURG LLP, 122 EAST 42ND STREET, SUITE 4000, NEW YORK, NY, 10168, US

(21) Appl. No.: 10/467,602

(22) PCT Filed: Feb. 22, 2002
(86) PCT No.: PCT/DE02/00657

(30) Foreign Application Priority Data
Feb. 26, 2001 (DE) 101 10 292.5

(51) Int. Cl. B32B 9/00

(52) U.S. Cl. 428/692

(57) ABSTRACT

Current-dependent resistive component, especially one that can be used as a switch, sensor or storage element, a ≦4 nm thick layer of manganate which is provided with electrical contacts and has been applied on a substrate.

The invention relates to a component, which has a high or a low electrical resistance, depending on the magnitude of the current flowing through the component. In the case of this component, the resistance is switched over at particular values of the current also due to the action of a magnetic field. The component can be used particularly as a switch, sensor or storage element.

Components are already known, for which the magneto-resistive effect is utilized and which are suitable for various applications, such as movement sensors or read/write heads for magnetic storage media. For this purpose, the phenomenon is utilized, according to which the value of the ohmic resistance of magneto-resistive materials changes as a function of the magnetization existing there. This change in resistance is ascertained with the help of measurement methods in that, for example, the strength of the current, flowing through the material, is determined.

For example, a probe, which contains a multilayer structure as functioning element, is known from U.S. Pat. No. 5,134,533. The multilayer structure consists of a stack of layers of a magnetic material, which are separated from one another by layers of a nonmagnetic material. The magnetic material is selected here from a group, formed by the metals Fe, Co and Ni, whereas the nonmagnetic material is selected from the metals Mn, Cr, V and Ti. In the case of this probe, a transition occurs in the magnetic material under the action of a magnetic field from a state of antiparallel alignment of the magnetization of adjacent magnetic layers into a state of parallel alignment and this transition is used for a switching effect.

The use of conductive manganese oxides in thin-layer resistances as intermediate layers between a resistive nitride layer and the electrical contacts is known, in order to improve the long-term stable functioning of the resistance element at elevated temperatures up to about 150° C. (U.S. Pat. No. 4,737,757). The manganese oxide layer serves to avoid diffusion processes between the nitride layer and the electrical contact. However, this resistance element is not suitable for switching over the electrical resistance.

A layer system is also already known, for which an epitactically grown tunnel layer of an insulating material, which is a few nanometers thick (M. Viret et al., Europhys. Lett. 39(5), pp. 548-549 (1997), separates two ferromagnetic manganate layers. The manganate layers here are 25 nm and 33 nm thick. When an electrical voltage is applied between the manganate layers of this system under the action of a magnetic field, abrupt changes in the resistance in the direction perpendicular to the layer system were noted and originated here also from the transition between the state of antiparallel alignment of the magnetization of adjacent magnetic layers and the state of parallel alignment.

Furthermore, an antiferromagnetic, insulating manganese oxide MnO₃ is known as matrix, which, under the action of an electrical field or an electrical current, of adequate magnitude, assumes a ferromagnetic metal state with a decreased electrical resistance (EP 864 538 A1). In this connection, it is a question, for example, of one-piece crystal of Pr₁₋ₓCaₓMnO₃, for which a metallic conductivity channel in the material is produced under the effect of a field or current. The magnetic fields, required for this purpose, are of the order of 1 tesla and voltages of 100 V must be applied. The position and stability of the conductivity path within the insulating matrix phase depends greatly on the prior thermal history and on the prior swappings in the magnetic field. For this reason, it is also difficult to ensure the reproducible behavior, which is necessary for a sensor or a storage element.

It is an object of the invention to create a simply configured component, which has a high or low electrical resistance depending on the magnitude of the current flowing through the component and can therefore be used especially as a switch, sensor or storage element.

Pursuant to the invention, this objective is accomplished with a component, which consists of a ≦4 mm thick manganate layer, which is applied on a substrate, and is provided with electrical contacts.

Depending on the magnitude of a current, the manganate layer, which is very thin pursuant to the invention and used for the component, has two states with clearly different electrical resistances. In contrast to the known tunnel magnetoresistance elements, the two resistance states can be switched by specifying the magnitude of the current. Moreover, the component also has an electrical resistance, the switching behavior of which can be influenced by applying a magnetic field. The two effects can also be used advantageously in combination with one another.

In the inventively given thickness range for the practical conversion, the concrete thickness of the manganate layer depends on the materials used for the layer and on the microstructure of the layer. In this connection, it may be assumed that particularly advantageous properties can be achieved with a thickness of the manganate layer ranging from 1 nm to 3 nm. When fixing the thickness, it should also be taken into consideration that, if the thickness selected is too large, the manganates layer below the ferromagnetic ordering temperature T_{c} is metallic and exhibits a linear relationship between the current and the voltage, that is, a constant resistance. On the other hand, a manganate layer, which is too thin, has the properties of an electrical insulator with extremely high resistance values, which practically cannot be measured.

Advantageously, the manganate layer consists of a manganese perowskite or a material of the general formula R₋ₓAₓMnO_{3+d} in which R represents La, a rare earth element, Y or a mixture of several of these elements. A is a metal, which is not trivalent. The value of d is −0.1 to 0.05. Especially Ca, Sr, Ba, Pb, Ce, Na or K come into consideration as metal, which is not trivalent.

Preferably, the manganate layer consists of La_{0.7}Ca_{0.3}MnO₃ or La_{0.7}Sr_{0.3}MnO₃.

The layer may be disposed on an epitactic, monocrystalline substrate, which may, preferably consist of NdGaO₃ (110).

Pursuant to the invention, the manganate layer may also be constructed structured.

In order to achieve a good service life and to maintain the properties of the component, the manganate layer may be covered with a diffusion barrier layer.

Advantageously, a coupling agent layer and/or a diffusion barrier layer may be disposed between the manganate layer and the substrate.

Advantageously, several manganate layers may also be stacked on top of one another in a multilayer construction, in each case a layer of insulating material, 1 nm to 5 nm thick, being disposed between the manganate layers and at least one of the manganate layers being provided with electrical contacts. The layers of insulating material may consist of epitactically grown SrTiO₃, CaTiO₃, NdGaO₃ or CeO₂.

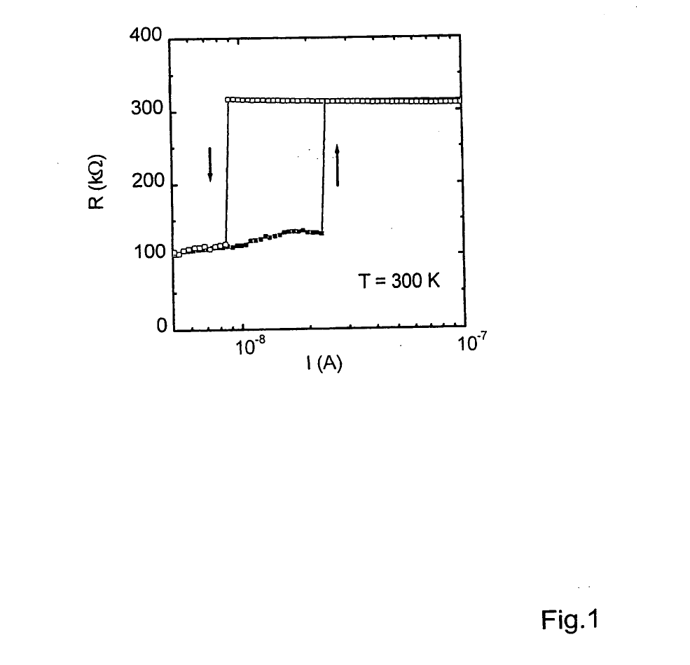

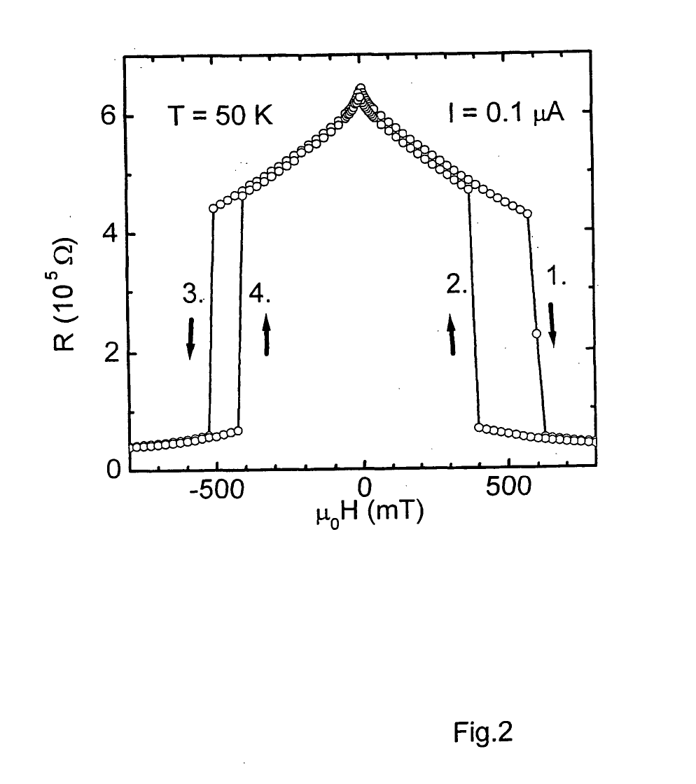

The invention is described below in greater detail by means of two examples. In the associated drawings of FIGS. 1 and 2, diagrams are shown, which have been measured at the two components described in Examples 1 and 2. Diagram 1 shows the course of the electrical resistance as a function of the magnitude of the current, supplied to the component. In Diagram 2, the course of the electrical resistance is shown as a function of an external magnetic field.

### EXAMPLE 1

This example relates to a component, for which a manganate layer is applied on a substrate 1 of NdGaO₃ (110), which is 0.5 nm thick. The manganate layer consists of La_{0.7}Ca_{0.3}MnO₃ and has a thickness of about 2 nm. The layer has been prepared using a stoichiometry target by means of a pulsed laser deposition in an atmosphere with 0.5 mbar oxygen. The manganate layer is provided with two electrical contacts, over which a current is supplied to the manganate layer.

When the power connections are supplied with different currents, the resistance behavior of the manganate layer at a temperature of 300° K is that shown in FIG. 1. The current supplied has been changed from small to large values and back again. The resistance exhibits a hysteresis behavior, which is characterized by different current values when the resistance is switched.

In the present example, the resistance behavior was determined from the values of the voltage drop over the manganate layer, which is measured at the voltage-tapping connections.

With the existing properties, it is possible to use the component as a current-dependent and magnetic field-dependent switch or sensor or as a current-dependent and magnetic field-dependent storage element.

### EXAMPLE 2

This example consists of a component, for which 21 manganate layers with 20 interposed layers of insulating material are stacked on top of one another on a 0.5 mm thick monocrystalline substrate of SrTiO₃ (100). The manganate layers consist of La_{0.7}Sr_{0.3}MnO₃₊ and are about 2 nm thick. The layers of insulating material consist of SrTiO₃ and are also about 2 nm thick. The multilayer was deposited using a stoichiometry target by means of pulsed laser deposition, as in Example 1. It is provided with two electrical contacts, over which current is supplied to the manganate layers.

When a current of 0.1 μA is supplied, the relationship, shown in FIG. 2, between the electrical resistance and a magnetic field, applied parallel to the layers, arises at a temperature of 50° K. The field was varied from 0 to 1 tesla and back again first in a positive and then in a negative field direction. The resistance exhibited hysteresis behavior.

The resistance behavior was determined as in Example 1.

This component can also be used as a current-dependent and magnetic field-dependent switch or as a sensor or storage element.

1. Current-dependent resistive component, especially one that can be used as a switch, sensor or storage element, characterized in that it consists of a ≦4 nm thick layer of manganate, which is provided with electrical contacts and has been applied on a substrate.

2. The component of claim 1, characterized in that the manganate layer has a thickness of 1 nm to 3 nm.

3. The component of claim 1, characterized in that the manganate layer consists of manganese perowskite.

4. The component of one of the claims 1 or 3, characterized in that the manganate layer consists of a material of the general formula R₁₋ₓAₓMnO_{3+d}, in which R represents La, a rare earth element, Y or a mixture of several of these elements, A represents a metal, which is not trivalent, and d=−0.1 to 0.05.

5. The component of claim 4, characterized in that the metal, which is not trivalent, is Ca, Sr, Ba, Pb, Ce, Na or K.

6. The component of claim 1, characterized in that the manganate layer consists of La_{0.7}Ca_{0.3}MnO₃ or La_{0.7}Sr_{0.3}MnO₃.

7. The component of claim 1, characterized in that the manganate layer is disposed on an epitactic, monocrystalline substrate, which consists preferably of NdGaO₃ or SrTiO₃.

8. The component of claim 1, characterized in that the manganate layer is constructed structured.

9. The component of claim 1, characterized in that a diffusion barrier layer covers the manganate layer.

10. The component of claim 1, characterized in that a layer of coupling agent and/or diffusion barrier is disposed between the manganate layer and the substrate.

11. The component of one of the claims 1 to 10, characterized in that several manganate layers are stacked one above the other in a multilayer construction, in each case an insulating layer, 1 nm to 5 nm thick, being disposed between the manganate layers and at least one on the manganate layers being provided with electrical contacts.

12. The component of claim 11, characterized in that the insulating material layers consist of epitactically grown SrTiO₃, CaTiO₃, NdGaO₃ or CeO₃.
